(19) United States
(12) Patent Application Publication
(10) Pub. No.: US 2025/0224121 A1
(43) Pub. Date: Jul. 10, 2025

(54) COOKING APPARATUS

(71) Applicant: SAMSUNG ELECTRONICS CO., LTD., Suwon-si (KR)

(72) Inventors: Jiwon JEONG, Suwon-si (KR); Heejin YOON, Suwon-si (KR); Byounghoon MOON, Suwon-si (KR); Chulwoo LEE, Suwon-si (KR); Kyunghee JUNG, Suwon-si (KR)

(73) Assignee: SAMSUNG ELECTRONICS CO., LTD., Suwon-si (KR)

(21) Appl. No.: 18/974,958

(22) Filed: Dec. 10, 2024

Related U.S. Application Data
(63) Continuation of application No. PCT/KR2024/018084, filed on Nov. 15, 2024.

(30) Foreign Application Priority Data
Jan. 5, 2024 (KR) 10-2024-0002530

(51) Int. Cl. F24C 15/20; H05B 6/64

(52) U.S. Cl. CPC F24C 15/2035; H05B 6/6426

(57) ABSTRACT

A cooking apparatus including a mounting frame with an inlet and a mounting portion; a filter configured to be mountable on the mounting frame to filter air passing through the inlet; and an elastic guide on one side of the filter to support the filter when the filter is mounted on the mounting frame, the elastic guide including a pressing portion configured to be pressed and deformed by the mounting frame while the filter is mounted on the mounting frame, and a latch guide configured to be deformable according to deformation of the pressing portion so that the latch guide is insertable into the mounting portion as the pressing portion is deformed by the mounting frame while the filter is being mounted on the mounting frame, and restorable to interfere with the mounting portion as the pressing portion is restored while the filter is being separated from the mounting frame.

### CROSS-REFERENCE TO RELATED APPLICATIONS

This application is a continuation application, claiming priority under § 365(c), of International Application No. PCT/KR2024/018084, filed on Nov. 15, 2024, which is based on and claims the benefit of Korean Patent Application Number 10-2024-0002530, filed on Jan. 5, 2024, the disclosures of which are incorporated by reference herein in their entireties.

### TECHNICAL FIELD

The present disclosure relates to a cooking apparatus including a filter.

### BACKGROUND ART

A microwave oven is a kitchen appliance that cooks food by simultaneously heating the inside and outside of the food by irradiating high frequency electromagnetic waves. Recently, an Over-The-Range (OTR) that combines a function of a hood for ventilation in a kitchen has been used.

The OTR may be installed on the wall to minimize installation space while making cooking food more convenient and efficient. The OTR may be installed on top of cooking appliance such as a gas range or a cooktop.

A filter may be provided inside the OTR to filter gas discharged from the cooking appliance.

### DISCLOSURE

### Technical Problem

The present disclosure is directed to providing a cooking apparatus having easy maintenance.

The present disclosure is directed to providing cooking apparatus capable of preventing falling of a filter.

Technical problems to be achieved by the present specification are not limited to the above-mentioned technical problems, and other technical problems not mentioned will be clearly understood by those skilled in the art to which the disclosure belongs from the following description.

### Technical Solution

Aspects of embodiments of the disclosure will be set forth in part in the description which follows and, in part, will be apparent from the description, or may be learned by practice of the presented embodiments.

According to an embodiment of the disclosure, a cooking apparatus includes a mounting frame in which an inlet is formed, the mounting frame including a mounting portion; a filter configured to be mountable on the mounting frame to filter out foreign substances in air passing through the inlet; and an elastic guide on one side of the filter to support the filter in response to the filter being mounted on the mounting frame, the elastic guide including a pressing portion configured to be pressed and deformed by the mounting frame while the filter is mounted on the mounting frame, and a latch guide configured to be deformable according to deformation of the pressing portion so that the latch guide is deformable so as to be insertable into the mounting portion as the pressing portion is deformed by the mounting frame while the filter is being mounted on the mounting frame, and restorable so as to interfere with the mounting portion as the pressing portion is restored while the filter is being separated from the mounting frame.

According to an embodiment of the disclosure, the latch guide may include a latch portion configured to interfere with the mounting portion in response to the filter being mounted on the mounting frame.

According to an embodiment of the disclosure, the latch guide may include a guide portion configured to be in contact with the mounting portion while the filter is being mounted on the mounting frame.

According to an embodiment of the disclosure, the latch guide may extend in a direction perpendicular to the one side of the filter while the filter is being mounted on the mounting frame, with the guide portion at an end of the latch portion.

According to an embodiment of the disclosure, the latch guide may include a connecting portion connecting the guide portion and the pressing portion, and configured to be bent from the pressing portion.

According to an embodiment of the disclosure, the connecting portion may extend in a direction perpendicular to the one side of the filter while the filter is being mounted on the mounting frame, and the connecting portion may extend from the pressing portion to the guide portion.

According to an embodiment of the disclosure, a distance between the one side of the filter and at least a portion of the pressing portion may be greater than a distance between the one side of the filter and the latch portion.

According to an embodiment of the disclosure, while the pressing portion is pressed by the mounting frame, the connecting portion and the latch portion may be deformed in a direction perpendicular to the one side of the filter.

According to an embodiment of the disclosure, a width of the guide portion may be less than a width of the mounting portion.

According to an embodiment of the disclosure, the mounting portion may include a first mounting portion, and a second mounting portion at a position spaced apart from the first mounting portion. The elastic guide may include a first latch guide configured to correspond to the first mounting portion so that a least a portion of the first latch guide is insertable into the first mounting portion, and a second latch guide configured to correspond to the second mounting portion so that a least a portion of the second latch guide is insertable into the second mounting portion.

According to an embodiment of the disclosure, the pressing portion may be formed to be convex in a direction away from the one side of the filter and toward the mounting frame.

According to an embodiment of the disclosure, the latch guide may include a pair of latch guides configured respectively at both ends of the pressing portion. The mounting portion may include a pair of mounting portions configured to correspond to the pair of latch guides.

According to an embodiment of the disclosure, the cooking apparatus may further include a protrusion provided on another side of the filter opposite to the one side of the filter. The mounting frame may include a mounting slot into which the protrusion is insertable.

According to an embodiment of the disclosure, in response to a pressing state, which is applied to the pressing portion by the mounting frame, being released while the filter is being mounted on the mounting frame, the filter may be moved to insert the protrusion into the mounting slot. In response to the pressing portion being pressed by the mounting frame while the filter is being separated from the mounting frame, the filter may be moved to so that the protrusion is separated from the mounting slot.

According to an embodiment of the disclosure, the elastic guide may include a metal material.

An aspect of the present disclosure provides a cooking apparatus disposed above a cooktop and provided with an inlet disposed on a lower side to face the cooktop, the cooking apparatus including: a filter configured to filter out foreign substances in air passing through the inlet; a mounting frame provided along a perimeter of the inlet to allow the filter to be mounted and including a mounting portion; and an elastic guide disposed on one edge of the filter and provided to allow at least a portion of the elastic guide to be inserted into the mounting portion, the elastic guide including a pressing portion provided to be pressed and deformed by the mounting frame while the filter is mounted on the mounting frame; and a latch guide provided to be deformed according to deformation of the pressing portion, the latch guide provided to be deformable so as to be insertable into the mounting portion as the pressing portion is deformed by the mounting frame while the filter is mounted on the mounting frame, and the latch guide provided to be restorable so as to interfere with the mounting portion as the pressing portion is restored while the filter is separated from the mounting frame.

An aspect of the present disclosure provides a cooking apparatus disposed above a cooktop and provided with an inlet disposed on a lower side to draw air generated in the cooktop, the cooking apparatus including: a filter configured to filter out foreign substances in air passing through the inlet; a mounting frame provided along a perimeter of the inlet to allow the filter to be mounted and including a pair of mounting portions; and an elastic guide disposed on one edge of the filter and provided to allow at least a portion of the elastic guide to be inserted into the mounting portion. The elastic guide includes a pressing portion provided to be pressed and deformed by the mounting frame while the filter is mounted on the mounting frame; and a pair of latch guides disposed at both ends of the pressing portion and provided to be inserted into each of the pair of mounting portions. While the pressing portion is pressed, the pair of latch guides are deformed in a direction approaching each other, and in response to a pressing state of the pressing portion being released, the pair of latch guides are deformed in a direction away from each other.

### DESCRIPTION OF DRAWINGS

These and/or other aspects of the disclosure will become apparent and more readily appreciated from the following description of embodiments, taken in conjunction with the accompanying drawings listed below.

FIG. 1 is a view illustrating a state in which a cooking apparatus is installed according to one embodiment.

FIG. 2 is a perspective view of the cooking apparatus according to one embodiment of the present disclosure.

FIG. 3 is a bottom perspective view of the cooking apparatus according to one embodiment.

FIG. 4 is a cross-sectional view illustrating some components mounted on the cooking apparatus of FIG. 2.

FIG. 5 is an exploded view illustrating some components of the cooking apparatus of FIG. 2.

FIG. 6 is a view illustrating the cooking apparatus of FIG. 5 when viewed from a different angle.

FIG. 7 is a front view illustrating a filter and an elastic guide according to one embodiment.

FIG. 8 is a view illustrating a process of mounting the filter provided with the elastic guide of FIG. 7 on a mounting frame.

FIG. 9 is a view illustrating the filter in a removable state without falling from the cooking apparatus according to one embodiment.

FIG. 10 is a view illustrating a filter and a fall prevention structure of a mounting frame according to one embodiment.

FIG. 11 is a cross-sectional view of some components to illustrate a filter and a fall prevention structure according to one embodiment.

FIG. 12 is an enlarged view of the fall prevention structure of FIG. 11.

FIG. 13 is a view illustrating some components of a fall prevention structure of a filter according to one embodiment.

FIG. 14 is a view illustrating some components of the fall prevention structure of the filter according to one embodiment when viewed from different angle.

FIG. 15 is a cross-sectional view of some components to illustrate a state in which the fall prevention structure of the filter of the FIGS. 13 and 14 is coupled.

FIG. 16 is a cross-sectional view illustrating a fall prevention structure of a filter according to one embodiment.

FIG. 17 is a view illustrating a process of mounting the filter provided with an elastic guide of FIG. 16 on a mounting frame.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “up and down direction”, “lower side”, “front and rear direction”, and the like may be defined based on the drawings, but the shape and the location of the component is not limited by the term.

The disclosure will be described more fully hereinafter with reference to the accompanying drawings.

In addition, for convenience of description, the following description will be made using an Over-The-Range (OTR), which is a type of cooking apparatus, but a configuration of the present disclosure is not limited to the OTR and may be applied to other cooking apparatus or ventilation facilities. For example, the configuration may be applied to other cooking apparatus including a filter or applied to ventilation facilities such as a range hood. Further, the configuration may be applied to any equipment, as long as it is a variety of air conditioning facilities including a filter.

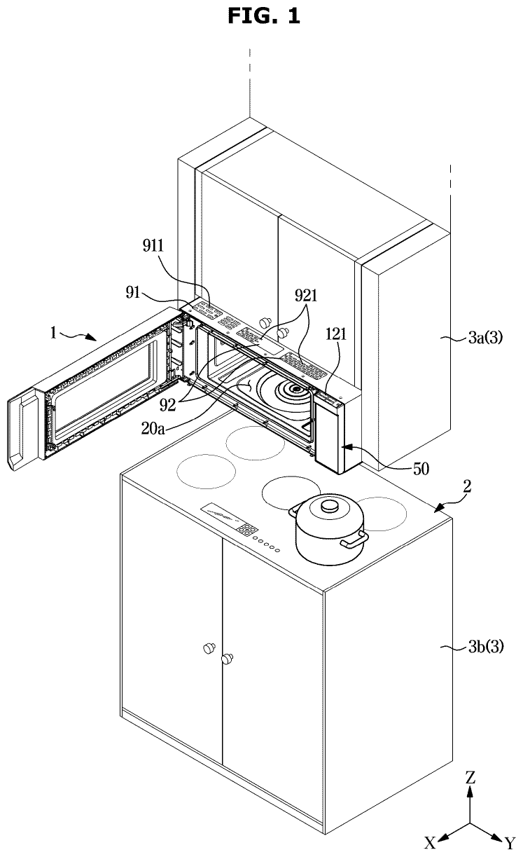

FIG. 1 is a view illustrating a state in which a cooking apparatus is installed according to one embodiment.

Referring to FIG. 1, a cooking apparatus 1 and a cooktop 2 may be installed on an external structure 3. The external structure 3 may include an upper storage cabinet 3a provided on an upper side of a kitchen space and a lower storage cabinet 3b provided on a lower side of the kitchen space. The external structure referred to in the disclosure may collectively refer to a storage cabinet, a drawer, a cupboard, a wall (W), etc.

The cooking apparatus 1 may be installed in the upper storage cabinet 3a. The cooktop 2 may be installed under the cooking apparatus 1 at a predetermined distance from the first cooking apparatus 1. For example, the cooktop 2 may be installed in the lower storage cabinet 3b.

The cooking apparatus 1 may be installed above the cooktop 2. The cooking apparatus 1 may draw in exhaust gas, vapor, smoke, or food odor generated from the cooktop 2 and discharge the drawn exhaust gas, vapor, smoke, or food odor to the outside. For example, the cooking apparatus 1 may perform a hood function. However, the function of the cooking apparatus 1 is not limited thereto, and the cooking apparatus 1 may cook food using high frequency electromagnetic waves through a magnetron or to cook food using a heater.

The cooking apparatus 1 according to one embodiment of the present disclosure may be provided as an Over-The-Range (OTR). Hereinafter the cooking apparatus 1 will be described.

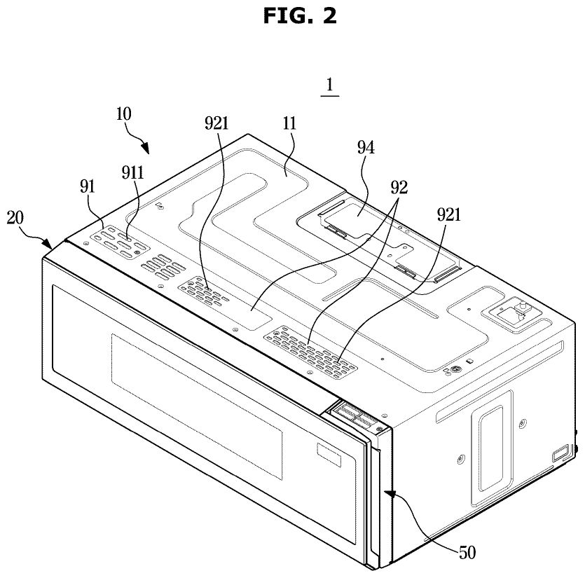

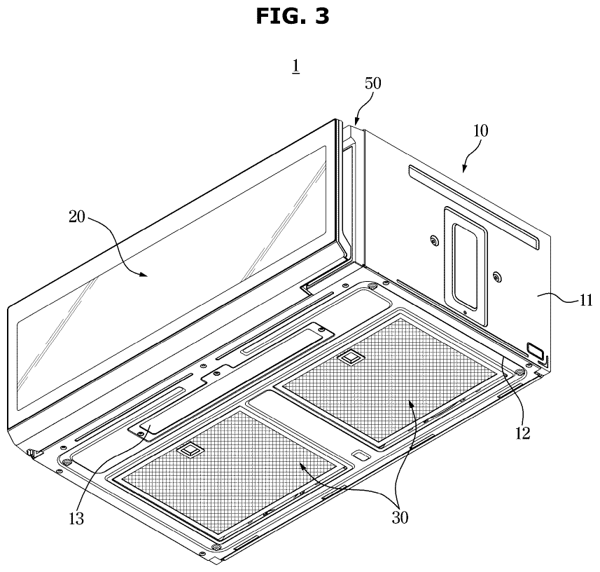

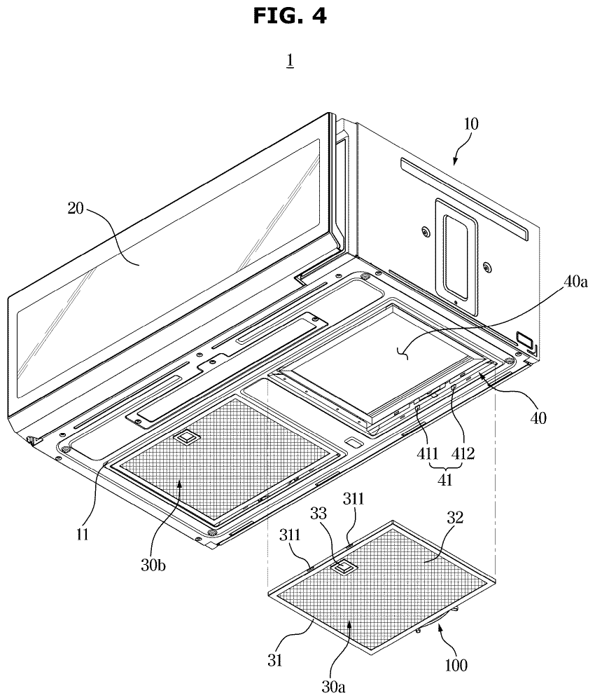

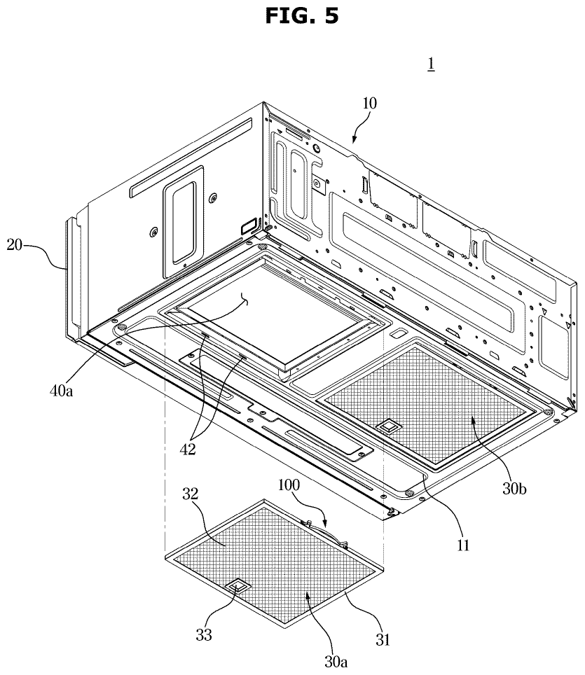

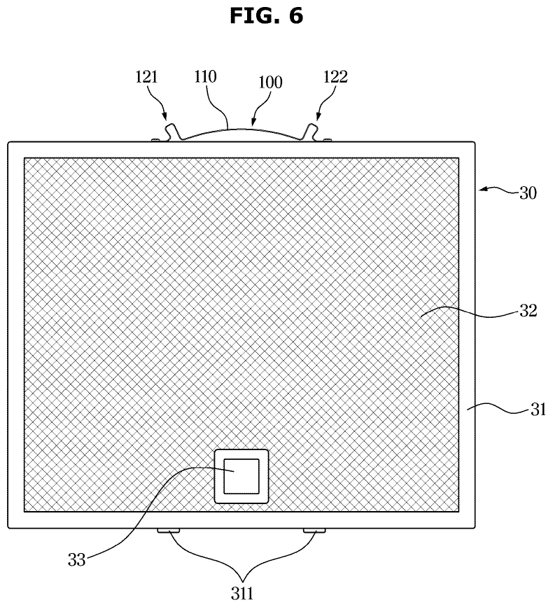

FIG. 2 is a perspective view of the cooking apparatus according to one embodiment of the present disclosure. FIG. 3 is a bottom perspective view of the cooking apparatus according to one embodiment. FIG. 4 is a cross-sectional view illustrating some components mounted on the cooking apparatus of FIG. 2. FIG. 5 is an exploded view illustrating some components of the cooking apparatus of FIG. 2. FIG. 6 is a view illustrating the cooking apparatus of FIG. 5 when viewed from a different angle.

Referring to FIGS. 2 to 6, the cooking apparatus 1 may be installed on the upper side of the cooktop 2. The cooking apparatus 1 is installed on a wall and is called a wall-mounted microwave oven or Over The Range (OTR).

The cooking apparatus 1 may include a main body 10 and a door 20 coupled to a front side of the main body 10. The cooking apparatus 1 may include a control unit 50 removably mounted to the front side of the main body 10.

The main body 10 may include an outer housing 11 and an inner housing (not shown) disposed inside the outer housing 11. A cooking chamber 20a and a power chamber (not shown) may be disposed inside the inner housing (not shown). The cooking chamber 20a and the power chamber (not shown) may be provided to be separated from each other.

The door 20 may be configured to open and close the cooking chamber 20a. Particularly, the door 20 may be rotatably coupled to the main body 10.

The cooking apparatus 1 may include the control unit 50 removably mounted on the front side of the main body 10. The front side of the control unit 50 may be covered by the door 20. More particularly, the control unit 50 may be coupled to the main body 10 so as to be disposed between the door 20 and the main body 10.

An inlet 40a may be formed on a lower surface of the main body 10. More particularly, the inlet 40a may be formed on a base plate 12 of the main body 10. Particularly, the inlet 40a may be formed by a mounting frame 40 provided to mount a filter 30 on the base plate 12.

Contaminated air that is generated on the lower side of the cooking apparatus 1 may be drawn into the inside of the cooking apparatus 1 through the inlet 40a. At this time, the contaminated air may include vapor, exhaust gas, smoke, foreign substances, food odors, etc. generated in a cooking space.

Contaminated air that is drawn into the cooking apparatus 1 may be filtered by the filter 30 inside the main body 10 and discharged to the outside of the cooking apparatus 1. The filter 30 may be arranged to correspond to the inlet 40a.

The main body 10 may include a lighting unit 13. The lighting unit 13 may be arranged in front of the inlet 40a. The lighting unit 13 may be configured to irradiate light toward the lower side of the cooking apparatus 1 when the cooktop 2, etc., is installed at the lower side of the cooking apparatus 1. A service panel 91 and a discharge panel 92 may be arranged on an upper surface of the main body 10. Particularly, the service panel 91 may be removably arranged on an upper surface of the outer housing 11. The discharge panel 92 may be removably arranged on the upper surface of the outer housing 11.

Further, a ventilation duct panel 94 may be arranged on the upper surface of the main body 10. The ventilation duct panel 94 may be removably mounted to the outer housing 11.

It is illustrated that two discharge panels 92 are provided according to one embodiment of the present disclosure, but the number of discharge panels 92 is not limited thereto.

The service panel 91 may include a first outlet 911. Each discharge panel 92 may include a second outlet 921.

Contaminated air that flows to the inside of the main body 10 through the inlet 40a formed on the lower surface of the main body 10 may be filtered and discharged to the outside of the cooking apparatus 1 through the first outlet 911 and the second outlet 921.

However, the present disclosure is not limited thereto, and when a separate chimney duct (not shown) connected to the outdoors is provided in a space in which the cooking apparatus 1 is installed, the service panel 91 and the discharge panel 92 may not include the first outlet 911 and the second outlet 921.

However, a circulating air outlet (not shown) communicating with the chimney duct (not shown) may be formed in the ventilation duct panel 94. In this case, the vapor introduced through the inlet 40a may be filtered and moved to the chimney duct (not shown) through the ventilation duct panel 94, which is disposed on an upper surface of a rear portion of the cooking apparatus 1, and discharged to the outdoors. That is, in this case, the filtered vapor may not be discharged indoors but may be discharged entirely to the outdoors.

In addition, because the service panel 91, the discharge panel 92, and the ventilation duct panel 94 are provided to be removable on the outer housing 11, the service panel 91, the discharge panel 92, and the ventilation duct panel 94 may be mounted on the outer housing 11 as needed.

Particularly, when a separate chimney duct (not shown) is not provided and thus the filtered air is required to be discharged indoors, a service panel 91 and a discharge panel 92 with a circulating air outlet may be mounted on the outer housing 11, and a ventilation duct panel 94 without a circulating air outlet may be mounted on the outer housing 11.

Conversely, when a separate chimney duct (not shown) is provided and thus the filtered air is not required to be discharged indoors, a service panel 91 and a discharge panel 92 without a circulating air outlet may be mounted on the outer housing 11, and a ventilation duct panel 94 with a circulating air outlet may be mounted on the outer housing 11.

The cooking apparatus 1 may include the filter 30 for filtering out foreign substances in air passing through the inlet 40a. The filter 30 may be disposed in the inlet 40a. Particularly, the filter 30 may be disposed in the inlet 40a to allow foreign substances, which are in the air flowing through a hood flow path (not shown), to be minimized.

The filter 30 may include a filter portion 32 provided to filter out foreign substances and a filter frame 31 provided to surround a perimeter of the filter portion 32. The filter frame 31 may support the filter 30 so as to maintain a certain shape.

At least one filter 30 may be provided. It is illustrated that the filter includes a first filter 30a and a second filter 30b disposed side by side according to one embodiment, but a single filter may be provided to cover the entire lower side of the cooking apparatus 1. Hereinafter the first filter 30a will be described, and a description of the first filter 30a may be applied to the second filter 30b.

A handle 33 provided to be held by a user to separate the first filter 30a from the main body 10 may be included. The handle 33 may be formed on a side opposite to a surface of the filter 30 facing the inlet 40a. While holding the handle 33, the user can separate the filter 30 from the main body 10 by pushing the handle 33 toward a direction in which an elastic guide 100 is installed. A process of mounting or separating the filter 30 will be described later.

The cooking apparatus 1 may include a blower fan (not shown) disposed inside the hood flow path (not shown). The blower fan (not shown) may allow air inside the hood flow path (not shown) to flow. The blower fan (not shown) may draw in outside air including exhaust gas generated from the cooktop 2 into the main body 10, and may allow the drawn air to flow through the hood flow path (not shown) and to blow out to the outlets 911 and 921.

The cooking apparatus 1 may include the mounting frame 40 in which the inlet 40a is formed. The mounting frame 40 may be disposed on the lower side of the main body 10. The mounting frame 40 may be disposed to face the cooktop 2. That is, the mounting frame 40 may be disposed to allow air containing foreign substances generated from the cooktop 2 to be efficiently introduced. However, the positions of the mounting frame 40 and the inlet 40a are not limited thereto, and may be disposed at various positions.

The mounting frame 40 may be formed by bending a portion of the base plate 12. Alternatively, the mounting frame 40 may be disposed along the perimeter of the inlet 40a formed in the base plate 12.

The cooking apparatus 1 may include the elastic guide 100 provided on one side of the filter 30. The elastic guide 100 may be configured to allow the filter 30 to be mounted on the mounting frame 40. The elastic guide 100 may be provided to support the filter 30 when the filter 30 is mounted on the mounting frame 40.

The filter 30 may be disposed in the inlet 40a. The filter 30 may be mounted on the mounting frame 40 forming the inlet 40a. Particularly, the elastic guide 100 provided on one side of the filter 30 and a protrusion 311 provided on the other side of the filter 30 may be supported by the mounting frame 40. In other words, one side of the mounting frame 40 may support the elastic guide 100, and the other side of the mounting frame 40 may support the protrusion 311 of the filter 30. However, the structure for mounting the filter 30 on the mounting frame 40 is not limited thereto and may be configured in various ways.

The filter 30 may be provided in a plate shape. The filter 30 may have a rectangular shape. However, the shape of the filter 30 is not limited thereto, and may be provided in various shapes such as a circular plate.

The elastic guide 100 may be disposed on one side of the filter 30. The elastic guide 100 may be disposed on one edge of the filter 30. Particularly, the elastic guide 100 may be disposed on one edge forming the filter frame 31. Accordingly, a mounting portion 41 may be disposed on the mounting frame 40.

The mounting frame 40 may include the mounting portion 41 formed in a portion of the mounting frame 40. The mounting portion 41 may be formed by cutting out a portion of the mounting frame 40. For example, the mounting portion 41 may be a hole or a groove formed in the mounting frame 40.

At least a portion of the elastic guide 100 may be inserted into the mounting portion 41. The mounting frame 40 may support a portion of the elastic guide 100 inserted into the mounting portion 41. Particularly, one edge forming the mounting portion 41 may support a portion of the elastic guide 100 inserted into the mounting portion 41.

The protrusion 311 may be disposed on the other side of the filter 30. Accordingly, the mounting frame 40 may include a mounting slot 42 into which the protrusion 311 is inserted. The protrusion 311 may be inserted into and supported in the mounting slot 42. Although not shown, the mounting slot 42 may be provided on the other side of the filter 30, and the protrusion 311 may be provided on the mounting frame 40.

In addition, it is illustrated that two protrusions 311 and two mounting slots 42 are provided according to one embodiment, but the number of protrusions 311 and mounting slots 42 is not limited thereto.

In a state in which the filter 30 is mounted on the mounting frame 40, the filter 30 may filter out foreign substances in the air passing through the inlet 40a. The filtered-out foreign substances may remain in the filter 30 and contaminate the filter 30.

Therefore, the filter 30 needs to be cleaned or replaced periodically. It is possible to separate the filter 30 from the mounting frame 40 to clean or replace the filter 30. When the filter 30 is separated, the filter 30 may fall or foreign substances remaining in the filter 30 may scatter. Therefore, when the filter 30 is separated, it is required to prevent the filter 30 from falling.

Hereinafter the structure for mounting the filter 30 on the mounting frame 40 will be described in details.

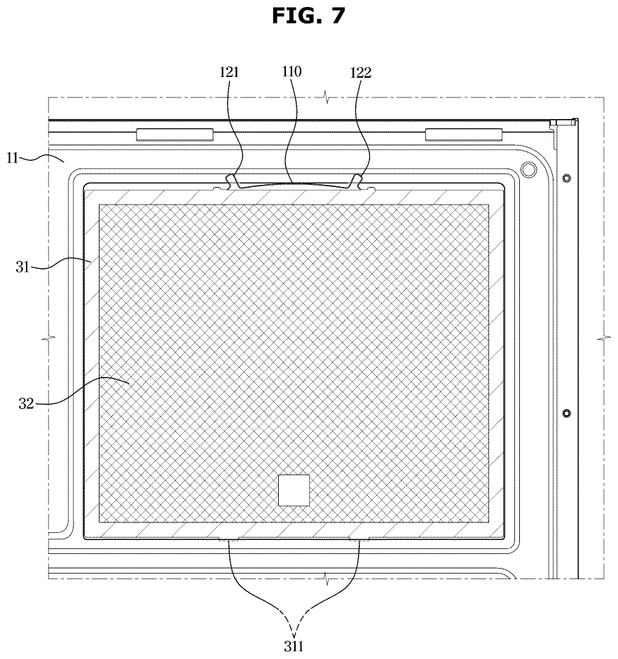

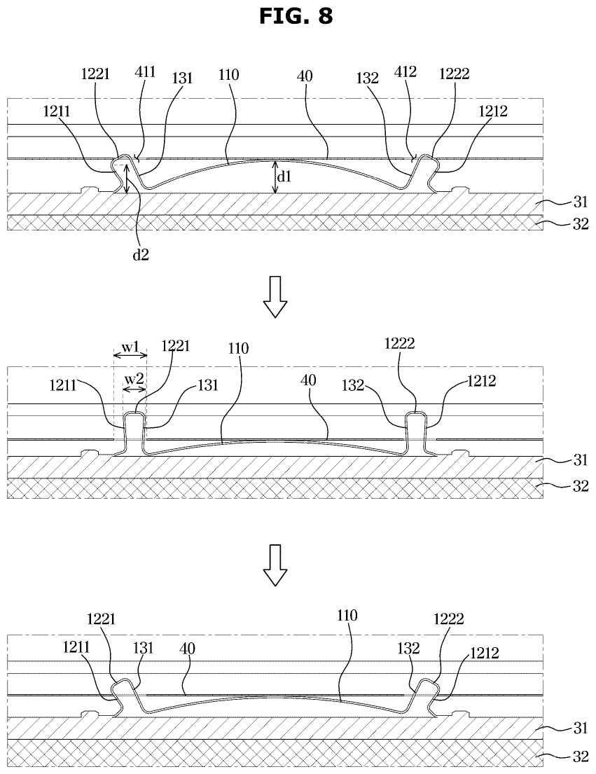

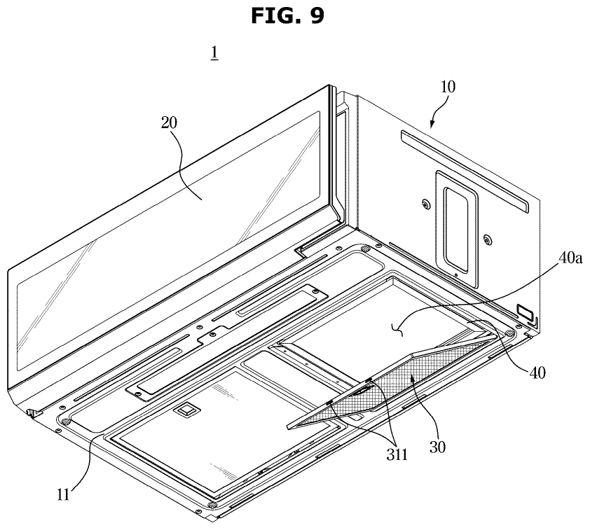

FIG. 7 is a front view illustrating the filter 30 and the elastic guide 100 according to one embodiment. FIG. 8 is a view illustrating a process of mounting the filter 30. FIG. 9 is a view illustrating the filter 30 in a removable state without falling from the cooking apparatus 1 according to one embodiment

Referring to FIGS. 7 and 8, the elastic guide 100 may be provided on one edge of the filter 30. The protrusion 311 may be provided on the other side of the filter 30. The elastic guide 100 may be provided on one edge of the filter 30, but the position thereof is not limited thereto.

The elastic guide 100 may be coupled to one edge of the filter 30. A coupling portion of the elastic guide 100 may be coupled to the filter frame 31.

The elastic guide 100 may include a pressing portion 110 provided to be pressed by the mounting frame 40. The pressing portion 110 may be pressed by the mounting frame 40 while the filter 30 is mounted on the mounting frame 40.

The pressing portion 110 may be formed to be convex toward a direction in which the filter 30 is mounted on the mounting frame 40. The pressing portion 110 may be formed symmetrically with respect to the direction in which the filter 30 is mounted on the mounting frame 40. In other words, a center of the pressing portion 110 may be located farthest from one side of the filter 30. In other words, a vertex of the pressing portion 110 may be located farthest from one side of the filter 30. For example, the pressing portion 110 may have a parabolic shape or an isosceles triangle shape. However, the shape of the pressing portion 110 is not limited thereto, and any shape may be used as long as it is formed to be convex toward the direction in which the filter 30 is mounted on the mounting frame 40.

In the pressing portion 110, a portion located farthest from one side of the filter 30 may be pressed first. Two ends of the pressing portion 110 may be deformed in a direction away from each other.

The elastic guide 100 may include latch guides 121 and 122 provided to be deformed according to the deformation of the pressing portion 110. The latch guides 121 and 122 may be deformed so as to be inserted into the mounting portion 41 while the filter 30 is mounted on the mounting frame 40. Particularly, while the filter 30 is mounted on the mounting frame 40, the pressing portion 110 may be deformed by the mounting frame 40, and the latch guides 121 and 122 may be deformed so as to be inserted into the mounting portion 41.

The latch guides 121 and 122 may be provided in a pair at both ends of the pressing portion 110. The latch guide 121 or 122 provided at one end of the pressing portion 110 may be referred to as a first latch guide 121, and the latch guide 121 or 122 provided at the other end of the pressing portion 110 may be referred to as a second latch guide 122. The following description will be based on the first latch guide 121, but the same description may also be applied to the second latch guide 122.

In the same manner as the latch guide, the mounting frame 40 may also include a first mounting portion 411 formed to allow at least a portion of the first latch guide 121 to be inserted, and a second mounting portion 412 formed to allow at least a portion of the second latch guide 122 to be inserted. The first latch guide 121 and the second latch guide 122 may be formed to be spaced apart from each other by a distance that the first mounting portion 411 and the second mounting portion 412 are spaced apart from each other.

The first latch guide 121 may include a first guide portion 1221 provided to be in contact with the first mounting portion 411 while the filter 30 is mounted on the mounting frame 40. The first guide portion 1221 may be provided to be in contact with one edge forming the first mounting portion 411. The first guide portion 1221 may be formed to correspond to the first mounting portion 411. That is, the guide portions may be spaced apart by a distance that the mounting portions are spaced apart from each other.

The first latch guide 121 may include a first connecting portion 131 connected to the pressing portion 110. The first connecting portion 131 may be bent from the pressing portion 110. The first connecting portion 131 may extend in a direction away from one side of the filter 30 as the first connecting portion 131 extends from the pressing portion 110. In other words, the first connecting portion 131 may extend in a direction of being inserted into the first mounting portion 411 as the first connecting portion 131 extends from the pressing portion 110.

Before the filter 30 is mounted on the mounting frame 40, the elastic guide 100 may be positioned to correspond to the mounting portion 41. The first guide portion 1221 of the elastic guide 100 may be positioned to be in contact with an edge forming the first mounting portion 411. That is, the first guide portion 1221 may be guided to correspond to the first mounting portion 411.

The first guide portion 1221 may be positioned to allow a portion thereof to be inserted into the first mounting portion 411. That is, the first guide portion 1221 may be formed to be inclined along a direction of being inserted into the first mounting portion 411 as the first guide portion 1221 faces the pressing portion 110. Similarly, the second guide portion 1222 may also be formed to be inclined to allow a portion thereof to be inserted into the second mounting portion 412. Accordingly, as the first guide portion 1221 and the second guide portion 1222 of the elastic guide 100 are inserted into the first mounting portion 411 and the second mounting portion 412, respectively, the position at which the elastic guide 100 is to be mounted may be guided.

When the elastic guide 100 is placed at a mounting position, it is possible to press the filter 30 to mount the filter 30 on the mounting frame 40. That is, the filter 30 may be pressed to allow the latch guides 121 and 122 to be inserted into the mounting portion 41 formed on the mounting frame 40. As a result, the elastic guide 100 provided on one side of the filter 30 may be pressed by the mounting frame 40.

While the elastic guide 100 is pressed toward the mounting frame 40, the first latch guide 121 may be deformed so as to be inserted into the first mounting portion 411. Particularly, as the pressing portion 110 of the elastic guide 100 is pressed, both ends of the pressing portion 110 may be moved in a direction away from the vertex of the pressing portion 110. That is, the pressing portion 110 may be deformed so as to be similar with a straight-line shape. In other words, both ends of the pressing portion 110 may be moved in opposite directions.

A distance between one side of the filter 30 and at least a portion of the pressing portion 110 may be formed to be greater than a distance between the one side of the filter 30 and a latch portion 1211. Because at least a portion of the pressing portion 110 is positioned further away from the latch portion 1211, the pressing portion 110 may be pressed first, which may cause deformation of the latch guides 121 and 122.

A distance d1 from one side of the filter 30 to the vertex of the pressing portion 110 may be greater than a distance from the one side of the filter 30 to a point in which the first latch portion 1211 and the first guide portion 1221 meet. The pressing portion 110 may be configured to press the filter 30 toward the mounting frame 40 while the pressing portion 110 is first pressed by the mounting frame 40. That is, a process of pressing the vertex of the pressing portion 110 may occur before a process of inserting the latch portions 1211 and 1212 into the mounting portions 411 and 412.

As mentioned above, when the pressing portion 110 is first pressed, deformation may occur in the latch guides 121 and 122. Particularly, the deformation may occur in the first connecting portion 131, which is connected to the pressing portion 110, in the first latch guide 121. A portion, which is connected to the pressing portion 110, of the first connecting portion 131 may be moved in a direction away from the pressing portion 110. In addition, a portion, which is connected to the first guide portion 1221, of the first connecting portion 131 may be moved in a direction closer to the pressing portion 110. In other words, the first connecting portion 131 may rotate in a direction perpendicular to the one side of the filter 30.

While the first connecting portion 131 is deformed in a direction perpendicular to the one side of the filter 30, the first guide portion 1221 connected to the first connecting portion 131 may also be deformed in the direction closer to the pressing portion 110. Because a portion, in which the first connecting portion 131 and the first guide portion 1221 are connected, is moved in a direction closer to the pressing portion 110, the first guide portion 1221 may be moved in a direction closer to the pressing portion 110.

Similarly, a portion, in which the first guide portion 1221 and the first latch portion 1211 are connected, may also be deformed in the direction closer to the pressing portion 110. As it is closer to the portion, which is connected to the first guide portion 1221, of the first latch portion 1211, the displacement may be increased. Accordingly, the first latch portion 1211 may be deformed in the direction perpendicular to the one side of the filter 30, similar to the first connecting portion 131.

At this time, the first guide portion 1221 may be deformed to be approximately parallel to the one side of the filter 30. In addition, a length of the first guide portion 1221 may be formed to be less than a width of the first mounting portion 411. Accordingly, the first latch guide 121 may be deformed to be insertable into the first mounting portion 411.

In summary, the elastic guide 100 may be positioned so as to be mounted on the mounting frame 40, and the elastic guide 100 may be pressed toward the mounting frame 40. The guide portions 1221 and 1222 of the latch guides 121 and 122 may be configured so as to be partially inserted into the mounting portions 411 and 412, and thus the position on which the elastic guide 100 is mounted may be guided. When the elastic guide 100 is pressed toward the mounting frame 40, the pressing portion 110 of the elastic guide 100 may be pressed first and thus the latch guides 121 and 122 may be deformed. While the pressing portion 110 is pressed by the mounting frame 40, the connecting portion and the latch portion may be deformed in the direction perpendicular to the one side of the filter 30. At this time, because a width w2 of the guide portion is formed to be less than a width w1 of the mounting portions 411 and 412, the latch guides 121 and 122 may be inserted into the mounting portions 411 and 412.

The first latch guide 121 may include the first latch portion 1211 provided to interfere with the first mounting portion 411 when the filter 30 is mounted on the mounting frame 40. The first latch portion 1211 may be provided to interfere with one edge forming the first mounting portion 411.

In a state in which the first latch guide 121 is inserted into the first mounting portion 411, a state in which the elastic guide 100 is pressed toward the mounting frame 40 may be released. When the state, in which the pressing portion 110 of the elastic guide 100 is pressed by the mounting frame 40, is released, the pressing portion 110 may push the mounting frame 40 by the elastic force of the pressing portion 110.

While the pressing portion 110 pushes the mounting frame 40, the elastic guide 100 and the filter 30 may be moved away from the mounting frame 40. At this time, the protrusion 311 formed on the opposite side of the elastic guide 100 may be inserted into the mounting slot 42 of the mounting frame 40. The mounting slot 42 may support the protrusion 311. The elastic guide 100 provided on one side of the filter 30 may be supported by the mounting portions 411 and 412 of the mounting frame 40, and the protrusion 311 provided on the other side of the filter 30 may be supported by the mounting slot 42 of the mounting frame 40. That is, the filter 30 may be mounted on the mounting frame 40.

When a force of the mounting frame 40 for pressing the pressing portion 110 is removed, the elastic guide 100 may be restored to an initial state thereof. That is, the first latch guide 121 may be restored to an initial state thereof while the first latch guide 121 is inserted into the first mounting portion 411. In other words, the first latch portion 1211 of the first latch guide 121 may be deformed again in the direction away from the pressing portion 110. Accordingly, while the filter 30 is separated from the mounting frame 40, the first latch portion 1211 may be deformed to interfere with one edge forming the first mounting portion 411.

The first latch guide 121 may be locked to the first mounting portion 411, and the second latch guide 122 may be locked to the second mounting portion 412. As a result, the filter 30 may be mounted on the mounting frame 40.

In order to separate the filter 30 from the mounting frame 40, the elastic guide 100 may be pressed toward the mounting portions 411 and 412 and thus the protrusion 311 may be detached from the mounting slot 42. At this time, because the protrusion 311 is not supported by the mounting slot 42, the filter 30 may fall due to gravity. The other side of the filter 30 may fall because the protrusion 311 is detached from the mounting slot 42.

Because the elastic guide 100 formed on one side of the filter 30 is locked to the mounting portions 411 and 412 of the mounting frame 40, the filter 30 may be locked to the mounting frame 40 without being completely detached from the mounting frame 40. Because the elastic guide 100 provided on one side of the filter 30 is locked to the mounting frame 40, the filter 30 may be prevented from falling.

Hereinafter embodiments other than those illustrated in FIGS. 1 to 8 will be described. The same components as those in the above embodiments are assigned the same reference numerals and a description thereof will be omitted, and other components will be described in detail.

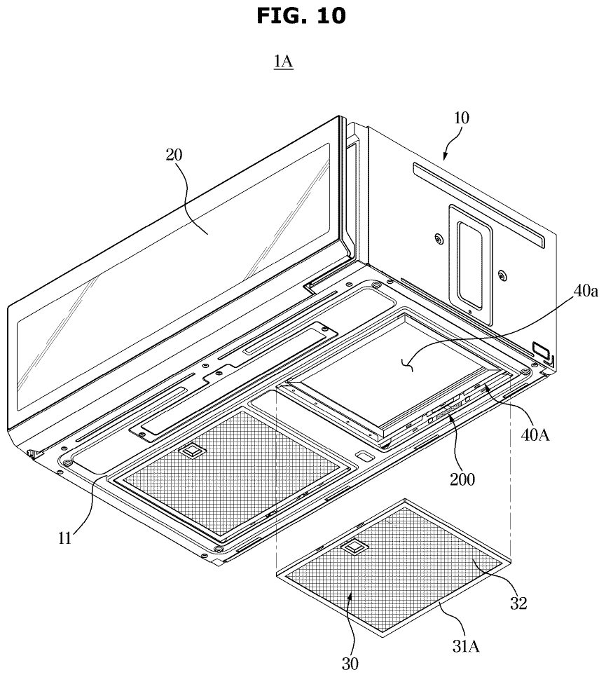

FIG. 10 is a view illustrating a filter and a fall prevention structure of a mounting frame according to one embodiment.

Referring to FIG. 10, a cooking apparatus 1A may include a magnetic body 200 provided on a mounting frame 40A. The magnetic body 200 may attach a filter frame 31A of a filter 30 to the mounting frame 40A.

The filter frame 31A may include a magnetic material. For example, the filter frame 31A may include a metal material.

It is illustrated that a separate locking structure is not provided in the filter frame 31A according to one embodiment. However, the present disclosure is not limited thereto, and the elastic guide 100 (refer to FIG. 6) of FIGS. 1 to 9 may be provided. The mounting frame 40A may include both the mounting portion 41 (refer to FIG. 6) provided to couple the elastic guide 100, and the magnetic body 200.

The magnetic body 200 may be disposed on one edge of the mounting frame 40A. The magnetic body 200 may be disposed on the opposite side to a mounting slot (not shown) of the mounting frame 40A. Particularly, the magnetic body 200 may be inserted into a portion of the mounting frame 40A. However, the present disclosure is not limited thereto, and the mounting frame 40A may include a magnetic material.

The filter frame 31 of the filter 30 is magnetically coupled to the magnetic body 200, and thus even when the protrusion 311 is detached from the mounting slot 42 to separate the filter 30, the filter 30 may be positioned in a state of being hung by the magnetic force. Accordingly, the falling of the filter 30 may be prevented.

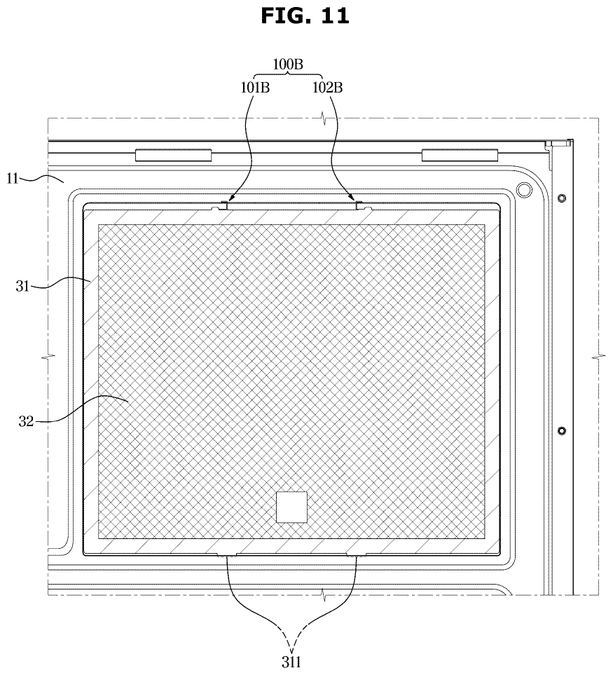

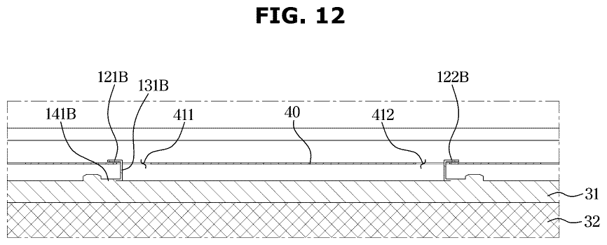

FIG. 11 is a cross-sectional view of some components to illustrate a filter and a fall prevention structure according to one embodiment. FIG. 12 is an enlarged view of the fall prevention structure of FIG. 11.

Referring to FIGS. 11 and 12, a hook guide 100B may be provided on one side of the filter 30.

The hook guide 100B may include a first hook guide 101B provided to be mounted on a first mounting portion 411, and a second hook guide 102B provided to be mounted on a second mounting portion 412.

For convenience of description, a description will be based on the first hook guide 101B, and the description of first hook guide 101B may also be applied to the second hook guide 102B.

The first hook guide 101B may include a first connecting portion 141B provided to be coupled to the filter frame 31. The first connecting portion 141B may be coupled to the filter frame 31. For example, the first connecting portion 141B may be fastened to the filter frame 31.

The first hook guide 101B may include a first connecting portion 131B bent from the first connecting portion 141B. The first connecting portion 131B may extend vertically from the first connecting portion 141B. The first connecting portion 131B may extend vertically with one edge of the filter frame 31.

The first hook guide 101B may include a first latch portion 121B provided to be inserted into the first mounting portion 411. The first latch portion 121B may be bent from the first connecting portion 131B. The first latch portion 121B may extend vertically from the first connecting portion 131B. The first latch portion 121B and the first connecting portion 131B may come into contact with one edge forming the first mounting portion 411.

The first latch portion 121B and a second latch portion 122B may extend in opposite directions. Particularly, the first latch portion 121B and the second latch portion 122B may extend in directions away from each other. In order to separate the filter 30 (refer to FIG. 3), it is appropriate that the first latch portion 121B and the second latch portion 122B extend in directions away from each other.

In order to mount the filter 30 on the mounting frame 40, the first hook guide 101B may be first inserted into the first mounting portion 411 and then the second hook guide 102B may be inserted into the second mounting portion 412. Alternatively, the second hook guide 102B may be first inserted into the second mounting portion 412 and then the first hook guide 101B may be inserted into the first mounting portion 411.

The first hook guide 101B and the second hook guide 102B may be spaced apart by a distance between the first mounting portion 411 and the second mounting portion 412. As a result, the first hook guide 101B and the second hook guide 102B may be positioned in a state of being locked to the mounting frame 40.

When the hook guide 100B is moved in a direction of being inserted into the mounting portions 411 and 412 to separate the filter 30, the protrusion 311 (refer to FIG. 3) may be detached from the mounting slot 42 (refer to FIG. 4). At this time, because the hook guide 100B is still locked to the mounting portions 411 and 412, the falling of the filter 30 may be prevented.

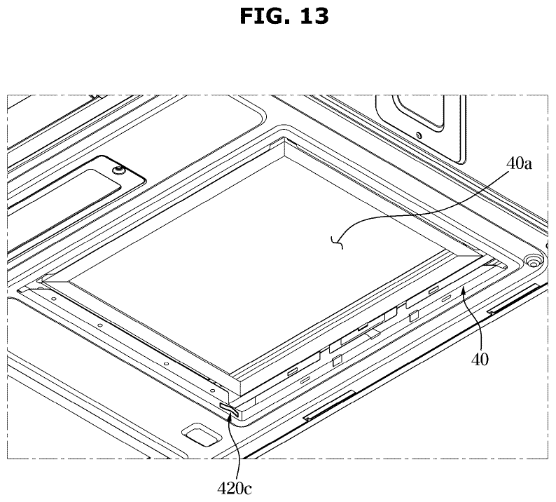

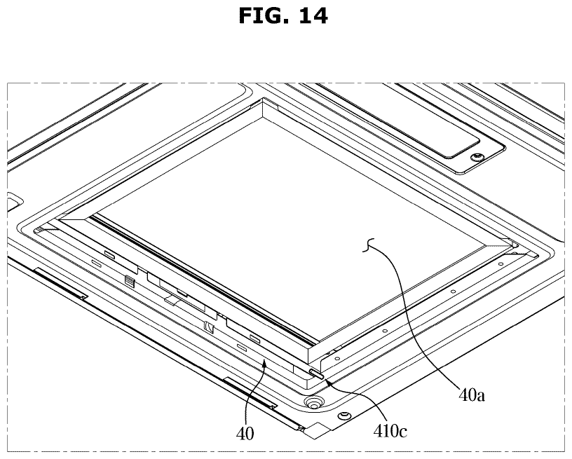

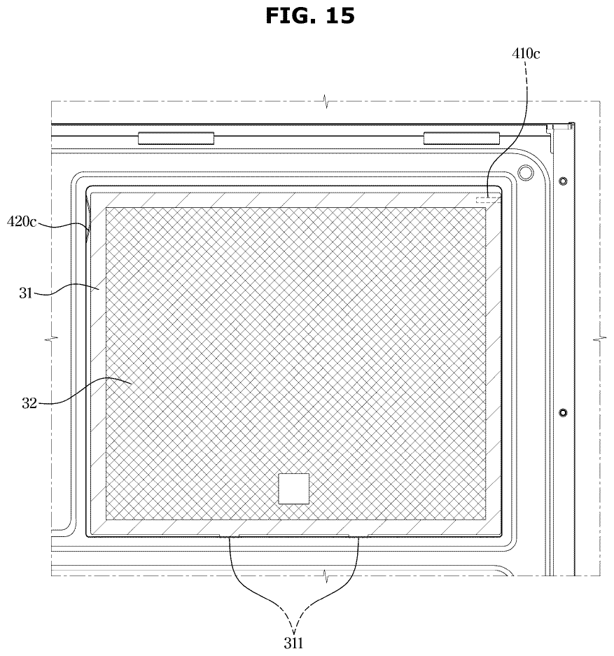

FIG. 13 is a view illustrating some components of a fall prevention structure of a filter according to one embodiment. FIG. 14 is a view illustrating some components of the fall prevention structure of the filter according to one embodiment when viewed from different angle. FIG. 15 is a cross-sectional view of some components to illustrate the fall prevention structure of the filter coupled to the FIGS. 13 and 14.

Referring to FIGS. 13 to 15, a hinge pin 410c and a plate spring 420c may be respectively provided on two edges of the mounting frame 40 in which the mounting portion 41 and the mounting slot 42 are not formed.

In order to mount the filter 30 on the mounting frame 40, the filter frame 31 may first be moved to press the plate spring 420c. While pressing the plate spring 420c, a gap may be formed between the filter 30 and one edge, in which the hinge pin 410c is provided, of the mounting frame 40.

An insertion hole (not shown) into which the hinge pin 410c is inserted may be formed in the filter frame 31. The hinge pin 410c may be inserted into the insertion hole (not shown) and thus the filter 30 may be positioned in a state of being locked to the hinge pin 410c.

The filter 30 may be supported so as not to be detached from the hinge pin 410c by an elastic force of the plate spring 420c provided on the opposite side of the hinge pin 410c.

Accordingly, even when the filter 30 is separated, the filter 30 may be positioned in a state of being hung to the mounting frame 40 by the hinge pin 410c and the plate spring 420c. That is, the falling of the filter 30 may be prevented.

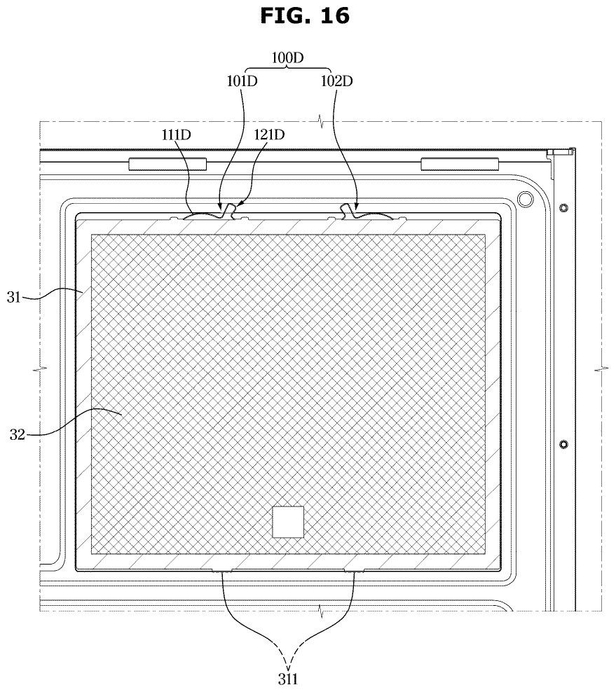

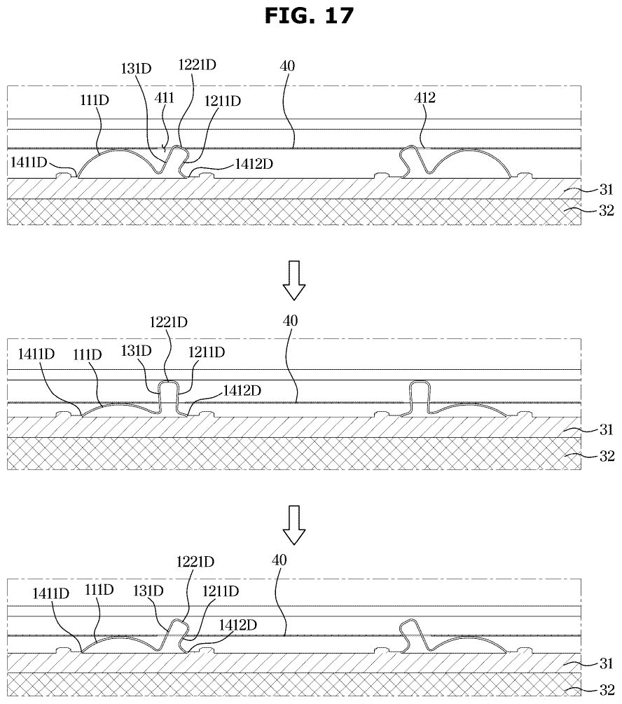

FIG. 16 is a cross-sectional view illustrating a fall prevention structure of a filter according to one embodiment. FIG. 17 is a view illustrating a process of mounting the filter provided with an elastic guide of FIG. 16 on a mounting frame.

Referring to FIGS. 16 and 17, a cooking apparatus 1D may include an elastic guide 100D provided on one side of the filter 30.

The elastic guide 100D may include a first elastic guide 101D provided to be inserted into the first mounting portion 411, and a second elastic guide 102D provided to be inserted into the second mounting portion 412. That is, the first elastic guide 101D may be provided to correspond to the first mounting portion 411, and the second elastic guide 102D may be provided to correspond to the second mounting portion 412.

For convenience of description, a description will be based on the first elastic guide 101D, and the description of the first elastic guide 101D may also be applied to the second elastic guide 102D.

The first elastic guide 101D may include a first pressing portion 111D configured to be pressed by the mounting frame 40. When the first pressing portion 111D is pressed by the mounting frame 40, a first latch guide 121D may be deformed so as to be insertable into the first mounting portion 411.

The first elastic guide 101D may include a first coupling portion 1411D configured to be coupled to the filter frame 31. The first coupling portion 1411D may be coupled and fixed to the filter frame 31.

While being pressed by the mounting frame 40, the first pressing portion 111D may deform a first connecting portion 131D and a first latch portion 1211D to a direction perpendicular to one side of the filter 30. In addition, the first pressing portion 111D may deform a first guide portion 1221D to a direction horizontal to the one side of the filter 30. Accordingly, the first latch guide 121D may be deformed into a state of being inserted into the first mounting portion 411.

While the first latch guide 121D is inserted into the first mounting portion 411, a pressing state applied to the first pressing portion 111D may be released. In other words, the filter 30 may be separated from the mounting frame 40. The first pressing portion 111D may be elastically restored to an original state thereof while pushing out the mounting frame 40. The first latch guide 121D may also be elastically restored to an original state thereof. That is, the first latch portion 1211D of the latch guide 121D may be deformed to interfere with one edge forming the first mounting portion 411.

While the first pressing portion 111D pushes the mounting frame 40, the filter 30 may be moved in the opposite direction to the direction in which the first elastic guide 101D is inserted into the first mounting portion 411. The protrusion 311 of the filter 30 may be inserted into the mounting slot 42 of the mounting frame 40 and supported by the mounting slot 42. Accordingly, the filter 30 may be mounted on the mounting frame 40 as the mounting portions 411 and 412 of the mounting frame 40 support the first elastic guide 101D and the second elastic guide 102D and the support slot 42 supports the protrusion 311.

When separating the filter 30 from the mounting frame 40, the first elastic guide 101D and the second elastic guide 102D may be pressed in the direction of the first mounting portion 411 and the second mounting portion 412 to detach the protrusion 311 from the mounting slot 42.

At this time, even when the filter 30 falls due to gravity, the first elastic guide 101D and the second elastic guide 102D may maintain a state of being hung by the first mounting portion 411 and the second mounting portion 412, and thus the falling of the filter 30 may be prevented.

The cooking apparatus 1 according to one embodiment may include the mounting frame 40 in which the inlet 40a is formed, the filter 30 configured to filter out foreign substances in air passing through the inlet, and the elastic guide 100 disposed on one side of the filter to support the filter in response to the filter being mounted on the mounting frame. The mounting frame may include the mounting portion 41 formed to allow at least a portion of the elastic guide to be inserted thereinto. The elastic guide may include the pressing portion 110 provided to be pressed and deformed by the mounting frame while the filter is mounted on the mounting frame, and the latch guides 121 and 122 provided to be deformed according to deformation of the pressing portion. The latch guide may be deformable so as to be insertable into the mounting portion as the pressing portion is deformed by the mounting frame while the filter is mounted on the mounting frame, and the latch guide may be restorable so as to interfere with the mounting portion as the pressing portion is restored while the filter is separated from the mounting frame.

The latch guide may include the latch portions 1211 and 1212 provided to interfere with the mounting portion in response to the filter being mounted on the mounting frame.

The latch guide may further include the guide portions 1221 and 1222 provided to be in contact with the mounting portion while the filter is mounted on the mounting frame.

The guide portion may extend in a direction away from the one side of the filter as the guide portion moves away from the latch portion.

The latch guide may further include the connecting portions 131 and 132 provided to connect the guide portion and the pressing portion and formed to be bent from the pressing portion.

The connecting portion may extend in a direction away from the one side of the filter as the connecting portion extends from the pressing portion.

The distance between the one side of the filter and at least a portion of the pressing portion may be formed to be greater than a distance between the one side of the filter and the latch portion.

While the pressing portion is pressed by the mounting frame, the connecting portion and the latch portion may be deformed in a direction perpendicular to the one side of the filter.

The width of the guide portion may be formed to be less than the width of the mounting portion.

The mounting portion may include the first mounting portion 411, and the second mounting portion 412 formed at a position spaced apart from the first mounting portion. The elastic guide may include the first elastic guide 101D provided to correspond to the first mounting portion and provided to allow a least a portion thereof to be inserted into the first mounting portion, and the second elastic guide 102D provided to correspond to the second mounting portion and provided to allow a least a portion thereof to be inserted into the second mounting portion.

The pressing portion may be formed to be convex toward a direction in which the filter is mounted on the mounting frame.

The latch guide may be provided in pairs at both ends of the pressing portion. The mounting portion may be provided in pairs to correspond to the pair of latch guides 121 and 122.

The cooking apparatus may further include the protrusion 311 provided on the other side of the filter. The mounting frame may further include the mounting slot 42 into which the protrusion is inserted.

In response to the pressing state, which is applied to the pressing portion by the mounting frame, being released, the filter may be moved to allow the protrusion to be inserted into the mounting slot. In response to the pressing portion being pressed by the mounting frame, the filter may be moved to allow the protrusion to be separated from the mounting slot.

The elastic guide may include a metal material.

The cooking apparatus 1 according to one embodiment may be disposed above the cooktop 2 and provided with the inlet 40a disposed on the lower side to draw air generated in the cooktop. The cooking apparatus may include the filter 30 configured to filter out foreign substances in air passing through the inlet, the mounting frame 40 provided along the perimeter of the inlet to allow the filter to be mounted and including the mounting portion 41, and the elastic guide 100 disposed on one edge of the filter and provided to allow at least a portion of the elastic guide to be inserted into the mounting portion. The elastic guide may include the pressing portion 110 provided to be pressed and deformed by the mounting frame while the filter is mounted on the mounting frame, and the latch guides 121 and 122 provided to be deformed according to deformation of the pressing portion, the latch guides 121 and 122 provided to be deformable so as to be insertable into the mounting portion as the pressing portion is deformed by the mounting frame while the filter is mounted on the mounting frame, and provided to be restorable so as to interfere with the mounting portion as the pressing portion is restored while the filter is separated from the mounting frame.

The latch guides may include the guide portions 1221 and 1222 provided to be in contact with one edge forming the mounting portion, the latch portions 1211 and 1212 provided to interfere with the one edge forming the mounting portion, and the connecting portions 131 and 132 provided to connect the guide portion and the pressing portion and formed to be bent from the pressing portion.

While the pressing portion is pressed by the mounting portion, the pressing portion may be deformed to extend along the one side of the filter, and the connecting portion and the latch portion may be deformed in a direction perpendicular to the one side of the filter.

The cooking apparatus 1 according to one embodiment may be disposed above the cooktop 2 and provided with the inlet 40a disposed on the lower side to face the cooktop. The cooking apparatus may include the filter 30 configured to filter out foreign substances in air passing through the inlet, the mounting frame 40 provided along the perimeter of the inlet to allow the filter to be mounted and including a pair of mounting portions 411 and 412, and the elastic guide 100 disposed on one edge of the filter and provided to allow at least a portion of the elastic guide to be inserted into the mounting portion. The elastic guide may include the pressing portion 110 provided to be pressed and deformed by the mounting frame while the filter is mounted on the mounting frame, and a pair of latch guides 121 and 122 disposed at both ends of the pressing portion and provided to be inserted into each of the pair of mounting portions. While the pressing portion is pressed, the pair of latch guides 121 and 122 may be deformed in a direction approaching each other, and in response to the pressing state of the pressing portion being released, the pair of latch guides may be deformed in a direction away from each other.

Each of the pair of the latch guides may include the guide portions 1221 and 1222 provided to be in contact with one edge forming the pair of the mounting portions, the latch portions 1211 and 1212 formed to be bent from the guide portion and provided to interfere with the one edge forming the mounting portion, and the connecting portions 131 and 132 provided to connect the guide portion and the pressing portion and formed to be bent from the pressing portion. While the pressing portion is pressed by the mounting portion, the connecting portion and the latch portion may be deformed in a direction perpendicular to the one side of the filter.

As is apparent from the above description, it is possible to easily maintain a cooking apparatus.

Further, it is possible to prevent a filter from falling when the filter is separated.

Additional aspects of the disclosure will be set forth in part in the description which follows and, in part, will be obvious from the description, or may be learned by practice of the disclosure

While the present disclosure has been particularly described with reference to exemplary embodiments, it should be understood by those of skilled in the art that various changes in form and details may be made without departing from the spirit and scope of the present disclosure.

1. A cooking apparatus comprising:
a mounting frame in which an inlet is formed, the mounting frame including a mounting portion;
a filter configured to be mountable on the mounting frame to filter out foreign substances in air passing through the inlet; and
an elastic guide on one side of the filter to support the filter in response to the filter being mounted on the mounting frame, the elastic guide including:
a pressing portion configured to be pressed and deformed by the mounting frame while the filter is mounted on the mounting frame, and
a latch guide configured to be deformable according to deformation of the pressing portion so that the latch guide is:
deformable so as to be insertable into the mounting portion as the pressing portion is deformed by the mounting frame while the filter is being mounted on the mounting frame, and
restorable so as to interfere with the mounting portion as the pressing portion is restored while the filter is being separated from the mounting frame.

2. The cooking apparatus of claim 1, wherein
the latch guide includes a latch portion configured to interfere with the mounting portion in response to the filter being mounted on the mounting frame.

3. The cooking apparatus of claim 2, wherein
the latch guide includes a guide portion configured to be in contact with the mounting portion while the filter is being mounted on the mounting frame.

4. The cooking apparatus of claim 3, wherein
the latch guide extends in a direction perpendicular to the one side of the filter while the filter is being mounted on the mounting frame, with the guide portion at an end of the latch portion.

5. The cooking apparatus of claim 3, wherein
the latch guide includes a connecting portion connecting the guide portion and the pressing portion, and configured to be bent from the pressing portion.

6. The cooking apparatus of claim 5, wherein
the connecting portion extends in a direction perpendicular to the one side of the filter while the filter is being mounted on the mounting frame, and the connecting portion extends from the pressing portion to the guide portion.

7. The cooking apparatus of claim 5, wherein
a distance between the one side of the filter and at least a portion of the pressing portion is greater than a distance between the one side of the filter and the latch portion.

8. The cooking apparatus of claim 5, wherein
while the pressing portion is pressed by the mounting frame, the connecting portion and the latch portion are deformed in a direction perpendicular to the one side of the filter.

9. The cooking apparatus of claim 8, wherein
a width of the guide portion is less than a width of the mounting portion.

10. The cooking apparatus of claim 1, wherein
the mounting portion includes:
a first mounting portion, and
a second mounting portion at a position spaced apart from the first mounting portion, and
the elastic guide includes:
a first latch guide configured to correspond to the first mounting portion so that a least a portion of the first latch guide is insertable into the first mounting portion, and
a second latch guide configured to correspond to the second mounting portion so that a least a portion of the second latch guide is insertable into the second mounting portion.

11. The cooking apparatus of claim 1, wherein
the pressing portion is formed to be convex in a direction away from the one side of the filter and toward the mounting frame.

12. The cooking apparatus of claim 11, wherein
the latch guide includes a pair of latch guides configured respectively at both ends of the pressing portion, and
the mounting portion includes a pair of mounting portions configured to correspond to the pair of latch guides.

13. The cooking apparatus of claim 1, further comprising:
a protrusion provided on another side of the filter opposite to the one side of the filter,
wherein the mounting frame includes a mounting slot into which the protrusion is insertable.

14. The cooking apparatus of claim 13, wherein
in response to a pressing state, which is applied to the pressing portion by the mounting frame, being released while the filter is being mounted on the mounting frame, the filter is moved to insert the protrusion into the mounting slot, and
in response to the pressing portion being pressed by the mounting frame while the filter is being separated from the mounting frame, the filter is moved to so that the protrusion is separated from the mounting slot.

15. The cooking apparatus of claim 1, wherein
the elastic guide includes a metal material.
